(19) United States
(12) Patent Application Publication
(10) Pub. No.: US 2002/0135842 A1
(43) Pub. Date: Sep. 26, 2002

(54) Method and apparatus for providing gain shape compensation

(76) Inventors: George Zarris, Kent (GB); David James Wall, Kent (GB)

Correspondence Address: SUGHRUE MION, PLLC, 2100 PENNSYLVANIA AVENUE, N.W., WASHINGTON, DC, 20037, US

(21) Appl. No.: 10/048,359

(22) PCT Filed: Jun. 4, 2001
(86) PCT No.: PCT/GB01/02454

(30) Foreign Application Priority Data
Jun. 2, 2000 (GB) 0013484.1

(51) Int. Cl. H04B 10/00; H04B 13/02

(52) U.S. Cl. 359/161; 359/141

(57) ABSTRACT

To monitor and compensate for gain shape variations in an optical fiber communication system usually a submarine such system, a low-frequency amplitude modulation is imposed at known amplitude upon location, usually a shore terminal (2). At another location, e.g. equalisation station (10), the received amplitude is monitored. Variations as between different channels represent response variations also in relation to signals and are compensated for.

### FIELD OF THE INVENTION

The present invention relates to a method and apparatus for providing gain shape monitoring and compensation for an optical communications system. The invention is particularly useful for use in a submarine optical communications system.

### BACKGROUND TO THE INVENTION

In high capacity long-haul wavelength division multiplexed (WDM) communications systems it is important to maintain a flat gain profile along the entire length of the system meaning that the gain experienced by an optical signal propagating through the system is substantially independent of its wavelength. To help achieve this, optical amplifiers used in such systems have gain flattened characteristics implemented with, for example, gain flattening filters. However, over an entire link of a system which may be thousands of kilometres long large numbers of amplifiers (typically, >100) are needed. Therefore, small deviations from ideal flatness in one individual amplifier is exacerbated by the similar deviations in other amplifiers in the concatenated series.

To address this problem, gain egualisers are used. These devices are positioned every certain number of amplifiers along the link and are arranged to correct for gain shape variations that arise due to the effect described above. The corrective shape that the equalisers can apply to amplifier outputs can either be determined during system assembly and test (known as passive equalisation) or for a greater degree of accuracy and flexibility the equalisers can be designed having an active unit controlled remotely from a Submarine Line Terminal Endstation (SLTE). Typically, a system would have several equalisers positioned at predetermined positions along the entire length of the cable, say after every twenty repeaters.

However, the overall flatness of the gain of the system is measured at the output of the system ie at one of the SLTEs. This makes the gain profile adjustment inaccurate since there is no information available about the gain shape of the system at the equalisers where the gain shape correction is actually provided. At present, trial and error is used to optimise the gain shape as detected at the SLTE. This is clearly undesirable.

### SUMMARY OF THE INVENTION

According to a first aspect of the present invention, a method of providing gain shape compensation to an optical communications system at a gain equaliser unit, comprises the steps of:

amplitude modulating each of a number of optical channels across a predetermined optical bandwidth with a modulation signal at an input to the communications system;

sensing the amplitude of the modulation of each of the channels at the gain equaliser unit; and,

adjusting the gain shape compensation provided by the equaliser unit in dependence upon the sensed amplitudes.

The present invention provides a method of gain shape compensation which can be used to compensate for variations in gain shape in dependence upon the gain shape at the same position that the correction is actually applied. Therefore, the inaccuracy which arises due to conventional trial and error methods described above is overcome.

Preferably, the modulation signal is applied to the optical signal at an endstation of the communications system.

According to a second aspect of the present invention, there is provided a gain equaliser unit suitable for attachment to the optical cable of an optical communications system, in which the equaliser unit comprises:

an optical detector arranged to receive an optical signal at each of a number of channel wavelengths from the communications system, each of which channel wavelengths is amplitude modulated with a test signal, and to sense the amplitude of the modulation; and,

means for providing gain shape compensation at the equaliser unit in dependence upon the sensed amplitudes of the modulation signals.

This enables the gain shape over an entire system bandwidth to be determined and compensated for accordingly.

Preferably, the optical detector is a PIN diode which is arranged to couple an electrical signal corresponding to a detected optical signal to an electrical filter. The filter is in turn arranged to transmit the frequency of the modulation applied to the optical signal to an AC voltmeter which is arranged to provide an electrical signal corresponding to the magnitude of the transmitted signal.

According to a third aspect of the present invention, there is provided an optical communications system comprising at least one gain equaliser unit according to the second aspect of the present invention.

Preferably, the communications system is a submarine communications system.

In a submarine communications system, it is difficult to monitor the gain shape at positions along the optical fibre due to the remote positioning of the cable and the fact that in most cases, it is located beneath the sea. The present invention provides a method and apparatus for gain shape monitoring and compensation which can operate in-service without operator communication at the point of compensation.

### BRIEF DESCRIPTION OF THE DRAWINGS

In order that the invention and its various other preferred features may be understood more easily, some embodiments thereof will now be described, by way of example only, with reference to the drawings, in which:

FIG. 1 is an example of a submarine communications system according to the present invention;

FIG. 2 is a schematic representation of the power of four optical wavelength channels on the system;

FIG. 3 is a schematic representation of an automatic gain equaliser unit constructed in accordance with a second aspect of the invention; and,

FIG. 4 is a schematic representation of an alternative gain equaliser constructed in accordance with the invention.

### DETAILED DESCRIPTION

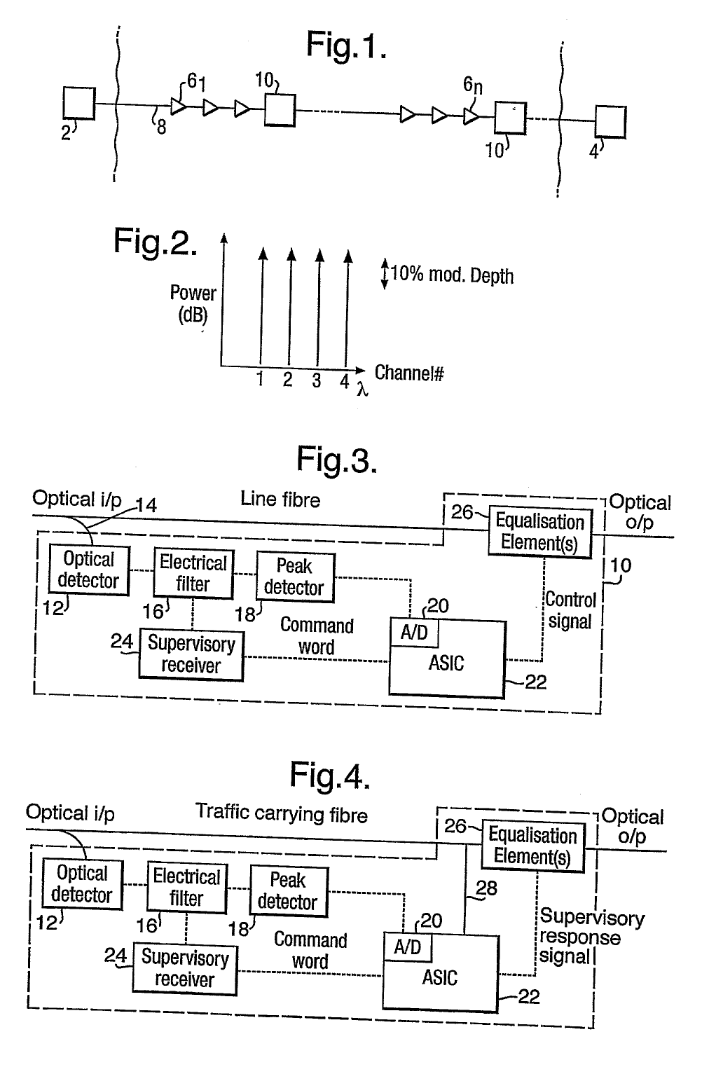

FIG. 1 shows a submarine communications system although the invention applies equally to any optical communications system. The system has first and second endstations 2 and 4 and a number of optical repeaters 6₁ to 6ₙ connected to optical cable 8 with predetermined separations therebetween. A number of gain equaliser units 10 are provided at positions along the optical cable. As will be explained below, the gain equaliser units are used to determine the gain profile of the system at that position on the cable. This information can then be used to provide gain shape compensation to the system, in dependence on the specific gain shape at that position.

One method of determining the gain shape of the system at the equaliser units will now be described with reference to FIG. 2. In a first step of the method, low frequency modulation of individual channels is executed by, for example, the endstation. Usually, the modulating wave will be imposed sequentially through at least most of the channels. The modulation frequency is chosen such that it does not interfere with the information content of the signals being transmitted—at frequencies which will usually be in the GHz range—on the respective channels, and a known modulation depth of usually not more than 10% is imposed. In a second step of the method, the amplitude of modulation of each channel is detected by each of the equaliser units. The modulation depth in the respective channels remains the same even though the optical signal varies in magnitude. We find that the amplitudes at the equaliser of the detected modulation frequencies is a function of the respective channel optical power levels. Therefore, by detecting the modulation level for each wavelength channel at the equaliser, it is possible to determine the gain shape of the system for wavelengths across the bandwidth of the measured channels. This information is then collated and used to determine the gain profile of the system at each equaliser unit. As will be described below, once a gain profile has been determined, any necessary correction is applied by setting the equaliser unit at a required compensation level.

In FIG. 2, channel 1 is first modulated by, say, 10% modulation depth at a frequency of 100 KHz. At the equaliser unit, the amplitude of the 100 KHz modulation frequency is detected. As explained above, the detected amplitude of the 100 kHz modulation frequency is proportional to the optical power of channel 1, and so, from this measurement it is possible to determine the channel power. This procedure is repeated for each channel under test in turn which enables the gain profile over the entire channel bandwidth to be determined. This information is employed to determine what equalisation is to be applied by the equaliser unit.

FIG. 3 shows an equaliser unit 10 which comprises an optical detector 12 having an input coupled to an optical tap coupler 14.

The output of the optical detector is coupled via a band pass filter 16 which passes the modulation frequency of 100 KHz to a peak detector 18 the output of which is coupled to an analog to digital converter 20. The output of the converter 20 is fed to a microprocessor 22 which is responsive to the output of a supervisory receiver 24 which is also coupled to an output of the electrical filter 16.

In operation of the system an end station such as 2 shown in FIG. 1 is arranged to transmit test signals, as described in connection with FIG. 2, on each channel in turn. These test signals are arranged to contain identification signals e.g. digital codes indicative of a particular sensing unit to be activated and the individual channel being modulated. The receiver 24 determines when a transmission is for its own equaliser unit and instructs the microprocessor to store modulation amplitude information relating to a specific channel. This process continues until all participating channels have been tested and information relating to the amplitude of the test signal has been stored. The microprocessor then produces an algorithm which is applied to equalisation elements 26 in the optical cable traffic carrying path. The elements then adjust the relative amplitudes of the channels. This process can be repeated periodically or selectively, The equalisation elements may comprise Faraday rotators and/or Raman amplifiers or any other suitable compensating element for providing gain shape adjustment.

An alternative manually controllable arrangement is illustrated in FIG. 4 with elements which are similar to the elements shown in FIG. 3 having the same reference numerals. In this arrangement, instead of storing in the microprocessor values sensed by the peak detector relating to each optical channel wavelength, the values are fed back to the remote station on a supervisory channel 28. The returned signals are assessed in the remote station by, for example, a spectrum analyser. Supervisory response signals can then be manually adjusted and sent to control individual equalisation elements 26 thereby to adjust the gain shape of the communications system. It will be appreciated that the response signals may have information relating to the address of specific equalisation units and equalisation elements to be controlled.

Some modifications of the previously described embodiments are envisaged and fall within the scope of this invention as follows:

1. The optical tap coupler 14 may be located after the equalisation elements 26 so that the signal assessed is the corrected value.

2. It would be possible to modulate a subset of adjacent channels instead of one at a time.

There is a possibility of transfer of the modulation signal between channels. This problem, known as intermodulation, is due to non-linear effects within the optical fibre of the communications system. If it is experienced it can be avoided by reducing the amplitude of the channel being modulated by, say, 5 dB.

Since the method relies on low level modulation of channels, that is a frequency which does not interfere with the information being transmitted on the system, the scheme can be implemented and function in-service. Thus, no disruption of traffic need take place to ensure gain flatness of the communication system over the entire system bandwidth. However, if the amplitude of the channel has to be reduced to avoid intermodulation, as mentioned in the previous paragraph, the operation cannot be in service unless a protection channel is employed instead. Protection channels offer redundancy in systems and can substitute channels which fail.

1. A method of providing gain shape compensation to an optical communications system at a gain equaliser unit, comprising the steps of:
amplitude modulating each of a number of optical channels across a predetermined optical bandwidth with a modulation signal at an input to the communications system;
sensing the amplitude of the modulation of each of the channels at the gain equaliser unit; and,
adjusting the gain shape compensation provided by the equaliser unit in dependence upon the sensed amplitudes.

2. A method according to claim 1, further comprising, prior to the step of adjusting the gain shape compensation provided by the equaliser unit, the step of:
determining the gain shape of the communications system at the equaliser unit in dependence on the sensed amplitudes.

3. A method according to claim 1 or 2, in which the modulation signal is applied to the optical signal at an endstation of the communications system.

4. A method according to any preceding claim, in which the modulation signal is applied to each of the wavelength channels in sequence.

5. A method according to claim 2, further comprising the step of transmitting information pertaining to the sensed amplitudes to an endstation of the communications system via a supervisory channel and providing gain shape compensation to the system from the endstation in dependence on the sensed amplitudes.

6. A gain equaliser unit suitable for attachment to the optical cable of an optical communications system, in which the equaliser unit comprises:
an optical detector arranged to receive an optical signal at each of a number of channel wavelengths from the communications system, each of which channel wavelengths is amplitude modulated with a test signal, and to sense the amplitude of the modulation; and,
means for providing gain shape compensation at the equaliser unit in dependence upon the sensed amplitude of the modulation signals.

7. A gain equaliser unit according to claim 6, further comprising means for determining the gain shape of the communications system at the equaliser unit in dependence on the sensed amplitudes.

8. A gain equaliser unit according to claims 6 or 7, in which the optical detector is a PIN diode.

9. A gain equaliser unit according to any one of claims 6 to 8, in which the optical detector is arranged to couple an electrical signal corresponding to the detected optical signal to an electrical filter arranged to transmit only the frequency of the modulation signal.

10. A gain equaliser unit according to claim 9, in which the electrical filter is arranged to couple the transmitted signal to a circuit capable of measuring peak-to-peak amplitude.

11. A gain equaliser unit according to any one of claims 5 to 10, further comprising means for automatically adjusting the gain of the communications system at the equaliser unit in dependence on the sensed amplitudes.

12. A gain equaliser unit according to claim 11, in which the means for automatically adjusting comprises a microprocessor arranged to store the sensed amplitudes and to provide an algorithm for adjusting for adjusting the gain in dependence upon the stored values.

13. A gain equaliser unit according to claim 12, in which the means for automatically adjusting further comprises an analog to digital converter for converting the sensed amplitudes prior to storage by the microprocessor.

14. A gain equaliser unit according to any of claims 6 to 13, in which the means for providing gain shape compensation comprises a Faraday rotator.

15. A gain equaliser unit according to any one of claims 6 to 14 in which the means for providing gain shape compensation comprises a Raman amplifier.

16. An optical communications system comprising at least one gain equaliser unit according to any of claims 6 to 15.

17. An optical communications system according to claim 16, in which the communications system is a submarine communications system.
